(19) United States
(12) Patent Application Publication
(10) Pub. No.: US 2001/0054015 A1
(43) Pub. Date: Dec. 20, 2001

(54) Method for facilitating the exchange of information over a computer network

(76) Inventor: Patrick Christian Michael Boucousis, Chapel Hill (AU)

Correspondence Address: Amy E. Rinaldo, Kohn & Associates, 30500 Northwestern Highway, Suite 410, Farmington Hills, MI, 48334, US

(21) Appl. No.: 09/881,991

(22) Filed: Jun. 15, 2001

Related U.S. Application Data
(60) Provisional application No. 60/211,837, filed on Jun. 15, 2000.

(51) Int. Cl. G06F 17/60; G06F 7/00; G06F 17/30

(52) U.S. Cl. 705/26; 707/3

(57) ABSTRACT

A method for facilitating the exchange of information between vendors and seekers of products and services comprises the steps of

entering vendors' item records as listings in an electronically searchable data structure;

searching said data structure on the basis of seeker queries generated by seekers;

subsequent to matching a seeker's query with listings of one or more vendors making available the identity of the seeker for viewing by the vendor corresponding to the matched listings and making available the identity of said vendors for viewing by the seeker.

Accordingly vendors are able to determine the identities of seekers who have been perusing their item listings. In a preferred embodiment the vendors are able to nominate seekers who are to be denied access to particular vendor records.

### BACKGROUND OF THE INVENTION

### FIELD OF THE INVENTION

The present invention relates to a method for facilitating seekers and vendors of products or services to exchange information by means of a computer network such as the Internet.

At present there are many web sites that cater for on-line sales of goods and services. For example, it is known to sell music recordings and other consumer products means of a web site. One such site encourages music retailers to submit listings of their inventories upon payment of a subscription. The site then provides a search engine for remote customers to browse the submitted inventories for items of interest. Upon locating an item of interest the details of the retailer holding the item are passed to the user. The user then contacts the retailer in order to make the purchase.

While the above system works reasonably well where products such as music recordings and books are concerned it is not appropriate for some types of industries. For example systems such as the previously described one have not been adopted for facilitating trade in capital intensive industries, where transaction value is high and where a prospective buyer has a potentially wide variety of options. The heavy equipment industry, also variously referred to as the earthmoving, construction and/or mining equipment industry, is one such capital intensive industry. In the heavy equipment industry there has been reluctance on the part of suppliers of equipment to make publicly available the details of their inventories. Consequently, to date there has been relatively little Internet facilitated trading of high-value products between organizations who are unknown to each other. Instead it is typical for customers to contact vendors, in say the heavy equipment industry, on a one-to-one basis either face-to-face, by telephone or fax or less commonly by means of a dedicated computer data link. Making numerous product and information inquiries in these ways is a time consuming undertaking for both the seeker and the vendor.

Furthermore, while it may be reasonably straightforward to categorize music recordings, books, and film items in a standard manner, the categorization of items such as mechanical parts for complex machines is difficult to standardize. As a result it is not uncommon for persons seeking a data record relating to a particular part to be unable to locate it because different parties refer it to in different ways making it difficult to search the records of a number of parties simultaneously.

Alternatively a seeker of information may be presented with many search results which are not relevant and which simply constitute a waste of resources to sift through.

While the above problems have been described in relation to the heavy equipment industry they are also present in other industries so that the present invention has a more general applicability.

### BRIEF SUMMARY OF THE INVENTION

It is an object of the present invention to provide a method for facilitating the exchange of information which addresses one or more of the above described problems.

The present invention provides a method for facilitating the electronic exchange of information between vendors and seekers who may be unknown to each other but where the vendor is prepared to make commercially sensitive information available to the seeker provided that there is a means of ensuring that the seeker will be positively identified to the vendor.

According to the present invention there is provided a method for facilitating the exchange of information between vendors and seekers, the method comprising the steps of:

entering vendors' item records as listings in an electronically searchable data structure;

searching said data structure on the basis of seeker queries generated by seekers;

upon matching a seeker's query with listings of one or more vendors making available the identity of the seeker for viewing by the vendors corresponding to the listing and making available the identity of said vendors for viewing by the seeker.

Preferably the method further includes the step of ensuring that the vendor's item records are for items appearing in an electronically searchable item catalogue.

Similarly, it is preferable that the method further includes the step of ensuring that seeker queries are in respect of items appearing in the item catalogue.

It is advantageous if the method further includes the step of providing for vendors to nominate seekers who are to be prevented having access to said vendors' records.

Preferably the seeker contact details are made available in an electronic form for downloading by the vendor.

Similarly, it is preferable that the vendors' contact details are made available for downloading by the seeker.

The method may further include the step of aiding the vendors to enter assemblies of items by providing a software module configured to recognize an item which is an assembly of parts and to generate a list of the component parts for entry into the data structure.

According to a further aspect of the present invention there is provided a network business application including:

an Internet accessible graphical user interface software module in communication with an electronically searchable listing catalogue of items offered for sale by vendors;

a retrieval software module configured to search the listing catalogue in respect of seeker search queries for items;

a search results software module configured to store seeker and vendor contact details for each instance of a search query matching a listing of the listing catalogue.

Preferably web site communicates with an electronically searchable item catalogue containing a list of all the items that can be listed in the listing catalogue.

Preferably the network business application includes a software module programmed to only enter a vendor listing into the listing catalogue if a corresponding listing first appears in the item catalogue.

In one embodiment of the invention said application is programmed to only search the listing catalogue in respect of seeker search queries that are for items appearing in the item catalogue.

Preferably the network business application also includes a software module configured to generate a listing of item identifiers being sub-parts of an assembly item in response to submission of the assembly item's identifier.

It is also desirable that said application further includes a software module configured to aid vendors in creating item listings for submission by presenting them with a series of options to select between.

Preferably said application further includes a filtering software module configured to allow a vendor to specify that the vendor's listings are not to be viewed by seekers specified by the vendor.

Preferably the business application is programmed to only search the listing catalogue in respect of seeker search queries that are for items appearing in the item catalogue.

It is desirable that the business application include a dismantler software module configured to generate a listing of item identifiers corresponding to sub-parts of an assembly item in response to submission of the assembly item's identifier.

Preferably the business application is configured to aid vendors in creating item listings for submission by presenting them with a series of options to select between.

### BRIEF DESCRIPTION OF THE DRAWINGS

FIG. 1 is a high-level block diagram of a computer system according to an embodiment of the present invention.

FIG. 2 is a stylized depiction of a computer screen generated by an embodiment of the present invention.

FIG. 3 is a block diagram of a network business application according to an embodiment of the present invention.

### DETAILED DESCRIPTION OF THE PREFERRED EMBODIMENT

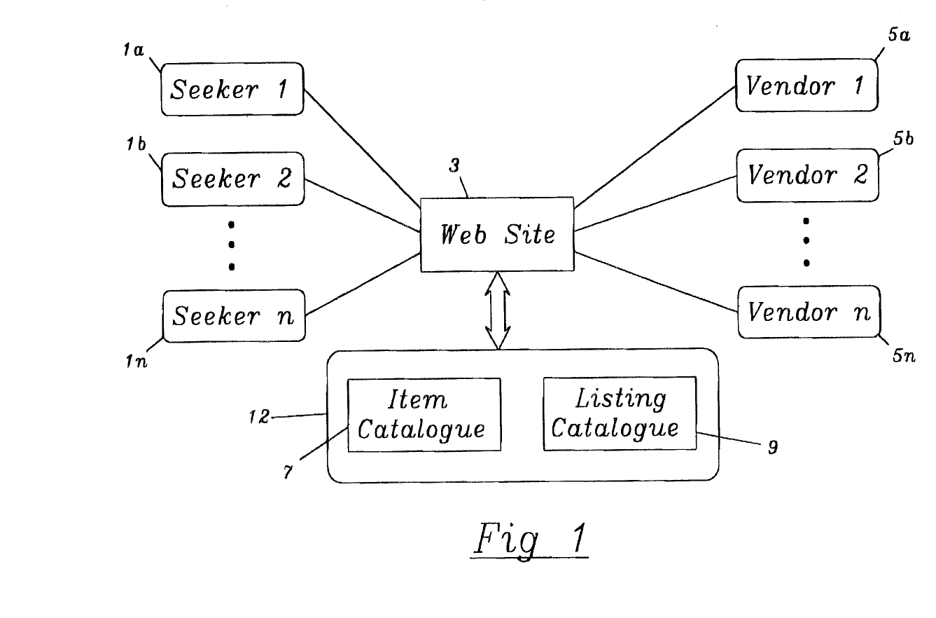

FIG. 1 is a generalized block-diagram of a system according to an embodiment of the present invention. With reference to FIG. 1, a number of remote seeker computer systems, 1a, . . . , 1n communicate via a computer network, such as the Internet, with a web site 3.

As will be explained, web site 3 is the front end of a network business application that also includes a database 12, with database management system and various software modules for compiling search queries extracting search results and manipulating data.

Web site 3 also communicates with the computer systems 5a, . . . , 5n of a number of vendors of equipment or information.

The web site accesses the electronically searchable database 12 including an electronically searchable data structure comprising item catalogue 7 that holds entries for a catalogue of items that may offered by the vendors and are of interest to the seekers. The searchable data structure further includes a listing catalogue 9 that lists items that are presently available from the vendors. Only items that have an entry in the item catalogue may be listed in the listing catalogue. An entry, or “listing” or “record”, in the listing catalogue will typically include information such as the identity of the vendor offering the item, the geographical location of the item, the price and time-frame for availability and the number of items available. Importantly, with each item for listing the vendor is able to nominate the identities of seekers that are not to have access to the vendor's listings. This feature allows each vendor to prevent competitors, for example, from gaining information concerning the state of the vendors inventory, such information may be commercially sensitive. Most usually the entries in the listing catalogue will refer to pieces of hardware, such as spare parts or equipment however they may also refer to “soft items” such as consultancy services, software for downloading or information items such technical specifications.

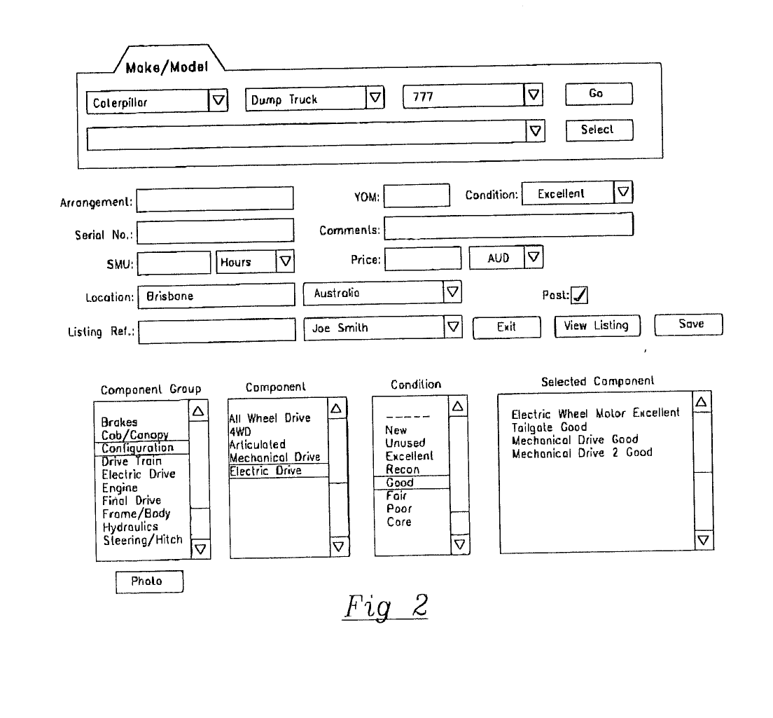

In order for a vendor, for example vendor 5n, to have items entered in the listing catalogue communication is established between the vendor's computer system and the administrator website 3 for example by means of an Internet browser software application. Upon establishing communication the website requests a unique subscriber ID code from the provider 5n. Once the identity of the provider is verified the provider is able to submit items for listing in the listing catalogue. Only items that appear in item catalogue 7 may be listed. In order to facilitate submission of items in a form that corresponds to the form of the item catalogue the vendor may be guided by means of a submission web page as shown in FIG. 2. The web page of FIG. 2 is configured to allow the vendor to enter information by selecting between a number of options in order to assemble a submission which corresponds to an entry in the item catalogue 7. If the item that the vendor wishes to submit does not correspond to an entry in item catalogue 7 then the vendor will not be able to list the item in listing catalogue 9.

It may be the case that the vendor has an assembled piece of equipment that he/she is prepared to sell either as a complete assembly or as separately available dissembled parts. As will be described later the web site may include a “dismantler” software module that, in response to being passed the item catalogue identity of the assembled piece of equipment, returns a listing of the item catalogue identities of each of the constituent parts. The vendor may then nominate entries for each of the constituent parts to be entered into the listing catalogue 9.

Subsequent to a vendor selling an item listed in listing catalogue 9, or if for some other reason the item is no longer available, then the vendor is able to re-establish communication with website 3 and update the currency of its listings.

The way in which a seeker of information makes use of website 3 will now be explained. Initially a seeker, for example seeker 1a, establishes contact with website 3 via the Internet by means of standard Internet communications and browser software. Once communication is established the seeker submits a unique subscriber ID code or password for verification by website 3. Subsequent to successful verification the seeker is able to access web pages that allow the seeker to submit a search query for an item of interest to be searched for. The item of interest must be an entry in the item catalogue 7. In order to ensure that only items which appear in item catalogue 7 are searched for in the listing catalogue 9, a search item entry web page may be used to aid in the correct formulation of search queries. For example the search query entry web page may be in the same form as the web page of FIG. 2 that is used by vendors to submit items for listing in catalogue 9.

Once the search query has been submitted in a form that corresponds with an entry in item catalogue 7, web site 3 initiates a search through listing catalogue 9. The search will disregard any entries in the listing catalogue that have the seeker's identity listed next to them as being a seeker that is not to have access to that listing.

In the event that there is a match between the search query and an entry in the listing catalogue, that the seeker is not barred from viewing, then the website displays a web page to the seeker informing them of the number of items in the listing catalogue that match their search query. It will be understood that the seeker may be confident at this point that the located items will be of direct relevance. This is because both the listings in the listing catalogue and the search query are in terms of entries in item catalogue 7.

The seeker is now presented with the option of proceeding to have the details of the located entries displayed. Where the seeker proceeds the seeker's contact details will be made available to the vendors corresponding to the located listings. In the event that the seeker decides to proceed then consent is indicated by clicking on a button of the displayed web page. In response the invention executes a search to identify full details of the vendors and their listings corresponding to the located listings and stores those details in the database as a “search result” which the seeker may access. The search result is stored in the database in such a way that each individual vendor who had one or more listings corresponding to the seeker's query may view the search result to the extent that it relates to their own listings. Seekers and vendors may view the search result on a computer screen or download search result information into their computer.

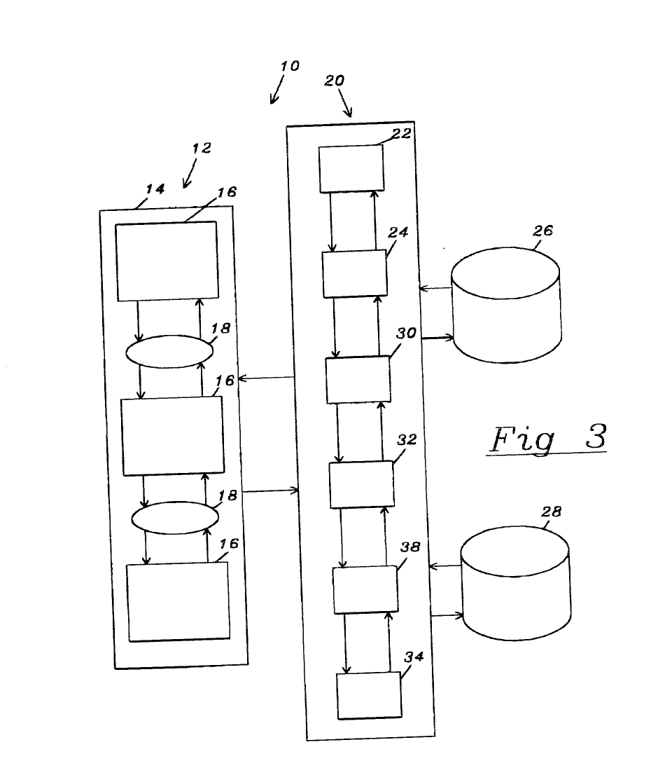

Referring now to FIG. 3, there is depicted a schematic diagram of a network business application 10 for carrying out the previously discussed method.

Application 10 includes a database 12 that is managed by a data base management system (DBMS) 14. The database 12 is structured to divide objects into sets of records 16 being the listings or entries of the previously described item catalogue and listing catalogue.

The relationship between the sets of records 16 is controlled via program functions 18 which implement suitable relational algorithms to operate on the database so that the database is in the form of a relational database. It follows that when a search is carried through the database 12, objects that correspond to each other within the records 16 are fetched and displayed together with a hit on any one of the objects in a particular record 16.

The objects stored in the database may include files of text or pictures or even video clips and sound bites describing the items that are available from the various vendors.

The DBMS 14 cooperates with database engine 20. The database engine 20 incorporates a retrieval software module 22 configured to retrieve objects that are presented together in a manner according to a constrained set of rules.

The database engine 20 includes an access control arrangement 24 to control access to the database 12. The access control arrangement 24 is configured so that only those users who have entered into an arrangement with the administrator of the system can access the database 12 for the purpose of searching the database or entering information into the database. In FIG. 3, reference 26 indicates a computer-based station of a vendor, i.e. one of computer systems 5a, . . . , 5n of FIG. 1. Similarly item 28 corresponds to one of the seeker computer stations 1a, . . . , 1n of FIG. 1.

Database engine 20 includes filtering software module 30 configured so that the vendor may nominate the identities of seekers that are barred from accessing the vendor's listings.

The database engine further includes a GUI software module 32 that supports web site 3 (FIG. 1) causing a web page to be displayed on stations 26 and 28 in order for the vendor and provider to submit and search listings. Typically the GUI is configured to generate web pages similar in appearance to those that are presently displayed on Internet browsers.

Upon a seeker requesting details of search results GUI software module 32 interacts with search results module 34 which is configured to store seeker and vendor contact details for each instance of the retrieval module matching a seeker's query with a vendor's listing catalogue entry. GUI software module 32 displays the details of the vendor in a form including contact name, organization and contact details such as e-mail address. Accordingly the seeker is able to readily establish direct communication with a vendor having an item of interest to the seeker. Similarly the vendors of the items located in the search may initiate a display of details of any hits received on their listings. They may then view each hit which will, for each item listing, contain details of seekers who created a query for that item. The details will include the seeker's contact name and organization and contact details including e-mail address.

DBMS 14 incorporates software that defines a naming system. It follows that items of information or objects are associated with a unique identifier. This allows vendors and seekers to enter plain language text objects when submitting information or making a search inquiry. The DBMS may be configured so that the unique identifiers are only used by the DBMS to identify information submitted by seekers or vendors. Alternatively the DBMS may be configured so that a seeker or vendor may use the identifiers to input or locate information respectively.

Database engine 20 also incorporates a “dismantler” software module 38. The dismantler program is configured to associate object descriptions with initially generic descriptions and then more specific descriptions.

The database contains a listing of objects that correspond with possible objects that would usually be stored in the database. The DBMS incorporates a naming system that acts on this listing to provide the listing with a tree structure. The GUI 32 is configured to permit vendors to enter information in a manner corresponding to the tree structure. Thus the GUI is configured to allow vendors to enter information by selecting, on a suitable input screen, generic names and then more specific names in order to identify the object that is to be made available to the seeker. As an alternative the GUI may also be configured to allow vendors or seekers to enter their listings or queries in a free text form with the GUI including a parser software module to convert the free text form into a format suitable for entry into the database.

It follows that the GUI software module is configured to permit a seeker to search for objects in accordance with the tree structure. Thus, the GUI may be configured so that the seeker is constrained to enter information in accordance with the tree structure.

Database engine 20 is configured to permit asynchronous data entry, by which it is meant that the database engine performs certain functions without interfering with the operations of seekers or vendors logged on to the system. Thus, for example, validation of one set of submitted data is able to occur while a vendor submits further sets of data, without re-drawing the screen presented to the vendor.

As previously mentioned, the present invention is described primarily with reference to the heavy equipment industry. Industrial equipment can usually be divided into two generic forms, namely composites, or assembled, items of equipment and various components or spare/replacement parts for the composite equipment. It follows that where vendor wishes to dispose of a composite item, the GUI software module 32 provides the ability to enter details of the part in a selection manner as shown in FIG. 4. The GUI 32 also provides a vendor with the ability to select a particular identifier associated with the part to be disposed of.

The dismantler program 38 cooperates with the GUI 32 to dismantle information into a tree-like arrangement. This is shown in the web page representations as “component group”, “component” and “condition”. The dismantler program 38 cooperates with the GUI 32 so that the information in connection with a composite article may be dismantled into its virtual constituent parts, and so that the vendor can offer the different parts for separate disposal. Database 12 includes a listing of the constituent parts for each of a number of composite products. Both the constituent parts and the composite products are entries in item catalogue 7. Accordingly the vendor is provided with an aid to dismantling the composite product in order to dispose of the constituent parts.

It will, of course, be realized that the above has been given only by way of illustrative example of the invention and that all such modifications and variations thereto as would be apparent to persons skilled in the art are deemed to fall within the broad scope and ambit of the invention as set forth in the following claims.

The invention claimed is:

1. A method for facilitating the exchange of information between vendors and seekers, the method comprising the steps of:
entering vendors' item records as listings in an electronically searchable data structure;
searching said data structure on the basis of seeker queries generated by seekers;
subsequent to matching a seeker's query with listings of one or more vendors making available the identity of the seeker for viewing by the vendors corresponding to the matched listings and making available the identity of said vendors for viewing by the seeker.

2. A method according to claim 1, further including the step of ensuring that the vendor's item records are for items appearing in an electronically searchable item catalogue.

3. A method according to claim 2, further including the step of ensuring that seeker queries are in respect of items appearing in the item catalogue.

4. A method according to claim 1, further including the step of providing for each vendor to nominate seekers who are not to be granted access to said vendor's records.

5. A method according to claim 3, including the step of making seeker contact details available in an electronic form for downloading by the vendors.

6. A method according to claim 3, including the step of making the vendors' contact details available in an electronic form for downloading by the seeker.

7. A method according to claim 2, including the step of aiding the vendors to enter assemblies of items by providing a software module configured to recognize an item which is an assembly of parts and to generate a list of the component parts for entry into the data structure.

8. A network business application including:
an Internet accessible graphical user interface in communication with an electronically searchable listing catalogue of items offered for sale by vendors;
a software module configured to search the listing catalogue in respect of seeker search queries for items;
a search results software module configured to store seeker and vendor contact details for each instance of a search query matching a listing of the listing catalogue.

9. A network business application according to claim 8, including an electronically searchable item catalogue containing a list of items permitted to be listed in the listing catalogue.

10. A network business application according to claim 9, programmed to only enter a vendor listing into the listing catalogue if a corresponding listing first appears in the item catalogue.

11. A network business application according to claim 8 further including a filtering software module configured to allow a vendor to specify that the vendor's listings are not to be viewed by seekers specified by the vendor.

12. A network business application according to claim 10 programmed to only search the listing catalogue in respect of seeker search queries that are for items appearing in the item catalogue.

13. A network business application according to claim 12 including a dismantler software module configured to generate a listing of item identifiers being sub-parts of an assembly item in response to submission of the assembly item's identifier.

14. A network business application according to claim 13 including a software module configured to aid vendors in creating item listings for submission by presenting them with a series of options to select between.
